(19) United States
(12) Patent Application Publication
(10) Pub. No.: US 2010/0118945 A1
(43) Pub. Date: May 13, 2010

(54) METHOD AND APPARATUS FOR VIDEO ENCODING AND DECODING

(75) Inventors: Naofumi Wada, Yokohama-shi (JP); Takeshi Chujoh, Tokyo (JP); Tadaaki Masuda, Tokyo (JP); Reiko Noda, Kawasaki-shi (JP); Akiyuki Tanizawa, Kawasaki-shi (JP); Goki Yasuda, Kawasaki-shi (JP); Taichiro Shiodera, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/532,057

(22) PCT Filed: Mar. 18, 2008
(86) PCT No.: PCT/JP08/55013

§ 371 Date: Sep. 18, 2009

(30) Foreign Application Priority Data
Mar. 29, 2007 (JP) 2007-087863

(51) Int. Cl. H04N 7/32

(52) U.S. Cl. 375/240.12; 375/E07.246

(57) ABSTRACT

An video encoding apparatus includes a dividing unit 101 to divide an input image signal into to-be-encoded pixel blocks, a reblocking unit 102 to reblock each of the to-be-encoded pixel blocks to generate a first pixel block and a second pixel block, a first prediction unit 108A to perform prediction for the first pixel block using a first local decoded image corresponding to an encoded pixel to generate a first predicted image, a generation unit to generate a second local decoded image corresponding to the first pixel block using a first prediction error representing the difference between the first pixel block and the first predicted image, a second prediction unit 108B to perform prediction for the second pixel block using the first local decoded image and the second local decoded image to generate a second predicted image, an encoding unit 103-105 to transform and encode the first prediction error and a second prediction error representing the difference between the second pixel block and the second predicted image to generate first encoded data and second encoded data, and a multiplexing unit 111 to multiplex the first encoded data and the second encoded data to generate an encoded bitstream.

### TECHNICAL FIELD

The present invention relates to a method and apparatus for encoding/decoding a motion video or a still video.

### BACKGROUND ART

Recently, ITU-T and ISO/IEC have cooperatively recommended a video encoding method with a greatly improved encoding efficiency as ITU-T Rec. H.264 and ISO/IEC 14496-10 (to be referred to as H.264 hereinafter). Encoding schemes such as ISO/IEC MPEG-1, 2, and 4 and ITU-T H.261 and H.263 perform intra prediction on the frequency domain (DCT coefficient) after orthogonal transform to reduce the number of coded bits of transform coefficients. To the contrary, H.264 introduces direction prediction on the spatial domain (pixel region), thereby implementing a higher prediction efficiency than that of intra-frame prediction in ISO/IEC MPEG-1, 2, and 4.

Intra encoding of H.264 divides an image into macroblocks (16×16 pixel blocks) and encodes each macroblock in the raster scan order. A macroblock can be divided by an 8×8 pixel size and a 4×4 pixel size. One of them can be selected for each macroblock. For luminance signal prediction, intra prediction schemes are defined for the three kinds of pixel block sizes, which are called 16×16 pixel prediction, 8×8 pixel prediction, and 4×4 pixel prediction, respectively.

In the 16×16 pixel prediction, four encoding modes called vertical prediction, horizontal prediction, DC prediction, and plane prediction are defined. The pixel values of neighboring decoded macroblocks before application of a deblocking filter are used as reference pixel values for prediction processing.

In the 4×4 pixel prediction and the 8×8 pixel prediction, luminance signals in a macroblock are divided into 16 4×4 pixel blocks and four 8×8 pixel blocks. One of nine modes is selected for each of the pixel sub-blocks. Except DC prediction (mode 2) which performs prediction based on the average value of usable reference pixels, the nine modes have prediction directions shifted by 22.5°. Extrapolation (extrapolation prediction) is performed in the prediction directions, thereby generating a prediction signal. However, the 8×8 pixel prediction includes processing of executing 3-tap filtering for already encoded reference pixels to flatten the reference pixels to be used for prediction, thereby averaging encoding distortion.

### DISCLOSURE OF INVENTION

In intra-frame prediction of H.264, a to-be-encoded block in a macroblock can refer to only pixels on the left and upper sides in principle, as described above. Hence, in pixels having low correlation to the left and upper pixels (generally, the right and lower pixels distant from the reference pixels), prediction performance cannot be improved, and prediction errors increase.

It is an object of the present invention to implement a high prediction efficiency in intra encoding which performs prediction and transform-based encoding in units of pixel block, thereby improving the encoding efficiency.

According to a first aspect of the present invention, there is provided a video encoding method comprising:

dividing an input image into a plurality of to-be-encoded blocks; reblocking the to-be-encoded blocks by distributing pixels in the to-be-encoded blocks to a first pixel block and a second pixel block at a predetermined interval; performing prediction for the first pixel block using a first local decoded image corresponding to encoded pixels to generate a first predicted image; encoding a first prediction error representing a difference between the first pixel block and the first predicted image to generate first encoded data; generating a second local decoded image corresponding to the first pixel block using the first prediction error; performing prediction for the second pixel block using the first local decoded image and the second local decoded image to generate a second predicted image; encoding a second prediction error representing a difference between the second pixel block and the second predicted image to generate second encoded data; and multiplexing the first encoded data and the second encoded data to generate an encoded bitstream.

According to a second aspect of the present invention, there is provided a video encoding apparatus comprising: a dividing unit to divide an input image into a plurality of to-be-encoded blocks; a reblocking unit to reblock each of the to-be-encoded blocks to generate a first pixel block and a second pixel block; a first prediction unit to perform prediction for the first pixel block using a first local decoded image corresponding to encoded pixels to generate a first predicted image; a generation unit to generate a second local decoded image corresponding to the first pixel block using a first prediction error representing a difference between the first pixel block and the first predicted image; a second prediction unit to perform prediction for the second pixel block using the first local decoded image and the second local decoded image to generate a second predicted image; an encoding unit to encode the first prediction error and a second prediction error representing a difference between the second pixel block and the second predicted image to generate first encoded data and second encoded data; and a multiplexing unit to multiplex the first encoded data and the second encoded data to generate an encoded bitstream.

### BRIEF DESCRIPTION OF DRAWINGS

FIG. 1 is a block diagram showing a video encoding apparatus according to an embodiment of the present invention;

FIG. 2 is a flowchart illustrating the processing procedure of the video encoding apparatus in FIG. 1;

FIG. 3 is a view showing an example of a pixel distribution pattern and reblocking usable in the video encoding apparatus in FIG. 1;

FIG. 4 is a view showing another example of a pixel distribution pattern and reblocking usable in the video encoding apparatus in FIG. 1;

FIG. 5 is a view showing still another example of a pixel distribution pattern and reblocking usable in the video encoding apparatus in FIG. 1;

FIG. 6 is a block diagram showing an encoding apparatus according to another embodiment of the present invention;

FIG. 7 is a flowchart illustrating the processing procedure of the video encoding apparatus in FIG. 6;

FIG. 8 is a view showing pixel distribution patterns and reblocking selectable in the video encoding apparatus in FIG. 6;

FIG. 9 is a view showing an example of the encoding order of sub-blocks in various pixel distribution patterns;

FIG. 10 is a view showing another example of the encoding order of sub-blocks in various pixel distribution patterns;

FIG. 11 is a view showing a quantization parameter offset in various pixel distribution patterns;

FIG. 12 is a view showing interpolation pixel prediction methods in various pixel distribution patterns;

FIG. 13 is a view showing a syntax structure;

FIG. 14 is a view showing the data structure of macroblock layer syntax;

FIG. 15 is a view showing the data structure of macroblock prediction syntax;

FIG. 16 is a block diagram showing a video decoding apparatus according to an embodiment of the present invention;

FIG. 17 is a flowchart illustrating the processing procedure of the video decoding apparatus in FIG. 16;

FIG. 18 is a block diagram showing a video decoding apparatus according to another embodiment of the present invention; and

FIG. 19 is a flowchart illustrating the processing procedure of the video decoding apparatus in FIG. 18.

### BEST MODE FOR CARRYING OUT THE INVENTION

The embodiments of the present invention will now be described with reference to the accompanying drawings.

### First Embodiment

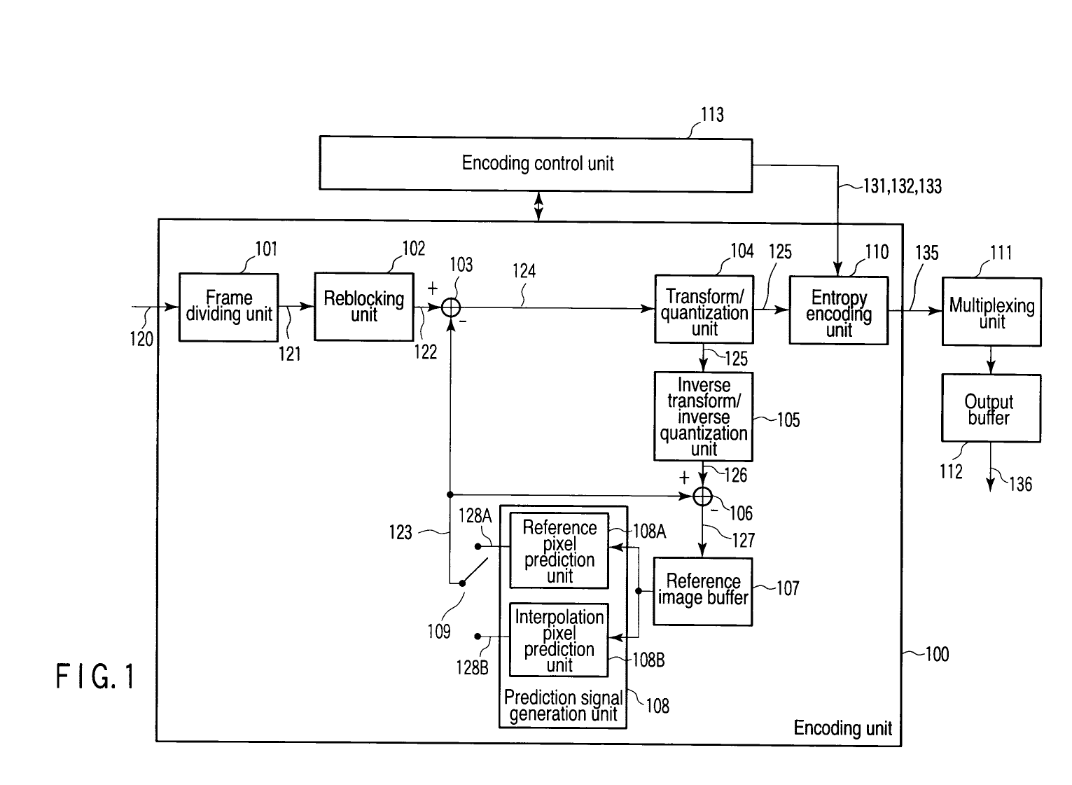

As shown in FIG. 1, a video encoding apparatus according to the first embodiment of the present invention includes an encoding unit 100, a multiplexing unit 111, an output buffer 112, and an encoding control unit 113 which controls the encoding unit 100. The encoding unit 100 encodes an input image signal 120 in the following way.

A frame dividing unit 101 divides the image signal 120 input to the encoding unit 100 into pixel blocks each having an appropriate size, e.g., macroblocks each including 16×16 pixels and outputs an to-be-encoded macroblock signal 121. The encoding unit 100 performs encoding processing of the to-be-encoded macroblock signal 121 in units of macroblock. That is, in this embodiment, the macroblock is the basic process block unit of the encoding processing.

A reblocking unit 102 reblocks the to-be-encoded macroblock 121 output from the frame dividing unit 101 into reference pixel blocks and interpolation pixel blocks by pixel distribution as will be described later. The reblocking unit 102 thus generates a reblocked signal 122. The reblocked signal 122 is input to a subtracter 103. The subtracter 103 calculates the difference between the reblocked signal 122 and a prediction signal 123 to be described later to generate a prediction error signal 124.

A transform/quantization unit 104 receives the prediction error signal 124 and generates transform coefficient data 125. The transform/quantization unit 104 first performs orthogonal transform of the prediction error signal 124 by, e.g., DCT (Discrete Cosine Transform). As another example of orthogonal transform, a method such as Wavelet transform or independent component analysis may be used. Transform coefficients obtained by the transform are quantized based on quantization parameters set in the encoding control unit 113 to be described later so that the transform coefficient data 125 representing the quantized transform coefficients is generated. The transform coefficient data 125 is input to an entropy encoding unit 110 and an inverse transform/inverse quantization unit 105.

The inverse transform/inverse quantization unit 105 inversely quantizes the transform coefficient data 125 based on the quantization parameters set in the encoding control unit 113 to generate transform coefficients. The inverse transform/inverse quantization unit 105 also inversely transforms the transform coefficients obtained by the inverse quantization with respect to the transform/quantization unit 104, e.g., performs IDCT (Inverse Discrete Cosine Transform). This generates a reconstructed prediction error signal 126 that is the same as the prediction error signal 124 output from the subtracter 103.

An adder 106 adds the reconstructed prediction error signal 126 generated by the inverse transform/inverse quantization unit 105 to the prediction signal 123 to generate a local decoded signal 127. The local decoded signal 127 is input to a reference image buffer 107. The reference image buffer 107 temporarily stores the local decoded signal 127 as a reference image signal. A prediction signal generation unit 108 refers to the reference image signal stored in the reference image buffer 107 when generating the prediction signal 123.

The prediction signal generation unit 108 includes a reference pixel prediction unit 108A and an interpolation pixel prediction unit 108B. Using the pixels (reference pixels) of the encoded reference image signal temporarily stored in the reference image buffer 107, the reference pixel prediction unit 108A and the interpolation pixel prediction unit 108B generate prediction signals 128A and 128B corresponding to the reference pixel blocks and the interpolation pixel blocks generated by the reblocking unit 102, respectively.

A switch 109 changes the connection point at the switching timing controlled by the encoding control unit 113 to select one of the prediction signals 128A and 128B generated by the reference pixel prediction unit 108A and the interpolation pixel prediction unit 108B. More specifically, the switch 109 first selects the prediction signal 128A corresponding to all reference pixel blocks in the to-be-encoded macroblock as the prediction signal 123. Then, the switch 109 selects the prediction signal 128B corresponding to all interpolation pixel blocks in the to-be-encoded macroblock as the prediction signal 123. The prediction signal 123 selected by the switch 109 is input to the subtracter 103.

On the other hand, the entropy encoding unit 110 performs entropy encoding for information such as the transform coefficient data 125 input from the transform/quantization unit 104, prediction mode information 131, block size switching information 132, encoded block information 133, and quantization parameters, thereby generating encoded data 135. As the entropy encoding method, for example, Huffman coding or arithmetic coding is used. The multiplexing unit 111 multiplexes the encoded data 135 output from the entropy encoding unit 110. The multiplexing unit 111 outputs the multiplexed encoded data as an encoded bitstream 136 via the output buffer 112.

The encoding control unit 113 controls the entire encoding processing by, e.g., feedback control of the number of encoded bits (the number of bits of the encoded data 135) to the encoding unit 100, quantization characteristic control, and mode control.

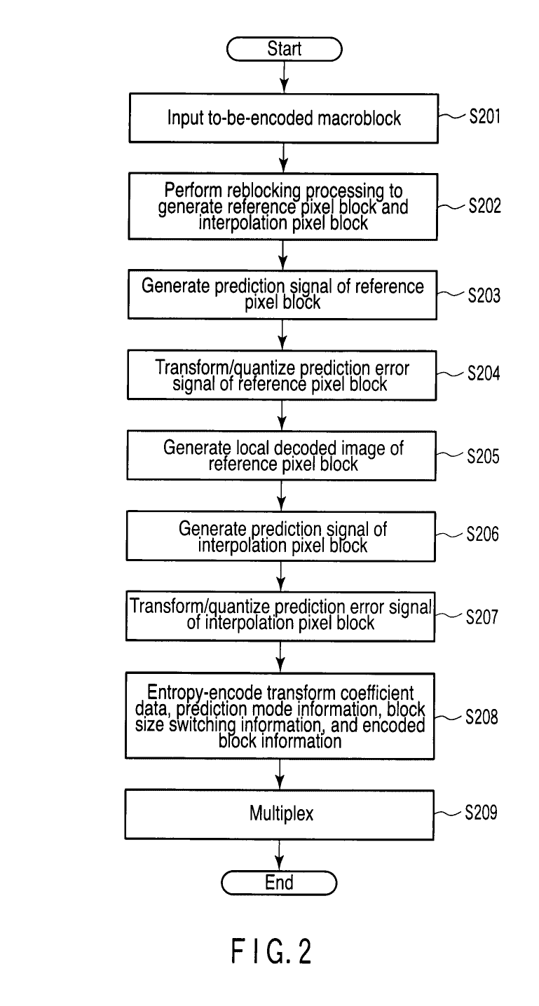

The operation of the video encoding apparatus shown in FIG. 1 will be described next in detail with reference to FIGS. 2 and 3 to 5. FIG. 2 is a flowchart illustrating the processing procedure of the video encoding apparatus in FIG. 1.

The frame dividing unit 101 divides the image signal 120 input to the encoding unit 100 in units of pixel block, e.g., in units of macroblock to generate a to-be-encoded macroblock signal 121. The to-be-encoded macroblock signal 121 is input to the encoding unit 100 (step S201), and encoding starts as will be described below.

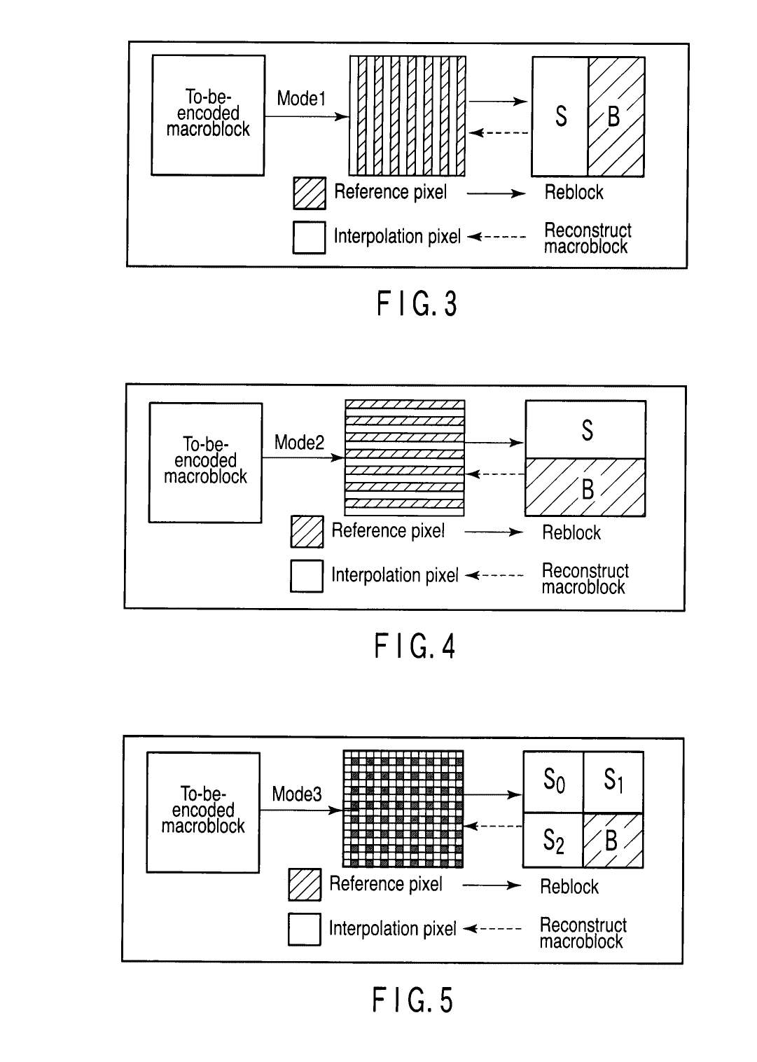

The reblocking unit 102 reblocks the to-be-encoded macroblock signal 121 input to the encoding unit 100 using pixel distribution, thereby generating reference pixel blocks and interpolation pixel blocks which serve as the reblocked signal 122 (step S202). The reblocking unit 102 will be described below with reference to FIGS. 3, 4, and 5.

The reblocking unit 102 performs pixel distribution in accordance with a pixel distribution pattern shown in, e.g., FIG. 3, 4, or 5. FIG. 3 shows a pattern on which the pixels of the to-be-encoded macroblock are alternately distributed in the horizontal direction. FIG. 4 shows a pattern on which the pixels of the to-be-encoded macroblock are alternately distributed in the vertical direction. FIG. 5 shows a pattern on which the pixels of the to-be-encoded macroblock are alternately distributed in the horizontal and vertical directions.

However, the pixel distribution patterns of the reblocking unit 102 need not always be the three patterns described above if they allow reblocking processing. For example, it may be a pattern on which the pixels of the to-be-encoded macroblock are distributed for every two or more arbitrary pixels in the horizontal or vertical direction.

Referring to FIGS. 3, 4, and 5, pixels of one type (indicated by hatched portions) distributed by the pixel distribution of the reblocking unit 102 will be referred to as reference pixels. Pixels of the other type (indicated by hollow portions) will be referred to as interpolation pixels. The reblocking unit 102 first classifies the pixels of the to-be-encoded macroblock into reference pixels and interpolation pixels. The reblocking unit 102 then performs reblocking processing for the reference pixels and the interpolation pixels, thereby generating reference pixel blocks and interpolation pixel blocks (step S202).

In reblocking, the reference pixels are preferably located at positions distant from encoded pixels in the neighborhood of the to-be-encoded macroblock. For example, if the neighboring pixels of the encoded pixels that are around the to-be-encoded macroblock exist on the left and upper sides of the macroblock, the reference pixels and the interpolation pixels are set as shown in FIGS. 3, 4, and 5.

In the pixel distribution pattern of FIG. 3, the reference pixel block is set at the right half position of the reblocked signal in the horizontal direction. Note that the position of the reference pixel block is not particularly limited to the right half position because encoding is performed in the order of reference pixel blocks→interpolation pixel blocks. Let P(X,Y) be the coordinates of a pixel position in the to-be-encoded macroblock. At this time, a pixel B(x,y) in a reference pixel block B and a pixel S(x,y) in an interpolation pixel block S are represented by the following equation 1.

B(x,y)=P(2x+1,y)

S(x,y)=P(2x,y)

In the pixel distribution pattern of FIG. 4, the reference pixel block is set at the lower half position of the reblocked signal in the vertical direction. As described above, the position of the reference pixel block is not particularly limited to the lower half position because encoding is performed in the order of reference pixel blocks→interpolation pixel blocks. At this time, the pixel B(x,y) in the reference pixel block B and the pixel S(x,y) in the interpolation pixel block S are represented by the following equation 2.

B(x,y)=P(x,2y+1)

S(x,y)=P(x,2y)

In the pixel distribution pattern of FIG. 5, the reference pixel block is set at the right position of the reblocked signal in the horizontal direction and at the lower position in the vertical direction. As described above, the position of the reference pixel block is not particularly limited to the lower right position because encoding is performed in the order of reference pixel blocks→interpolation pixel blocks. Referring to FIG. 5, three interpolation pixel blocks are generated. These interpolation pixel blocks are defined as S₀, S₁, and S₂, respectively. At this time, the pixel B(x,y) in the reference pixel block B and pixels S₀(x,y), S₁(x,y), and S₂(x,y) in the interpolation pixel blocks S₀, S₁, and S₂ are represented by the following equation 3.

B(x,y)=P(2x+1,2y+1)

S₀(x,y)=P(2x,2y)

S₁(x,y)=P(2x+1,2y)

S₂(x,y)=P(2x,2y+1)

The pixel distribution pattern shown in FIG. 3 forms a reference pixel block and an interpolation pixel block each having 8×16 pixels. The pixel distribution pattern shown in FIG. 4 forms a reference pixel block and an interpolation pixel block each having 16×8 pixels. The pixel distribution pattern shown in FIG. 5 forms a reference pixel block and interpolation pixel blocks each having 8×8 pixels. When encoding the reference pixel blocks and the interpolation pixel blocks, each of them may be divided into sub-blocks that are smaller pixel blocks, and each sub-block may be encoded as in intra-frame encoding of H.264, as will be described later in the second embodiment.

Next, the reference pixel prediction unit 108A in the prediction signal generation unit 108 generates the prediction signal 128A in correspondence with the reference pixel blocks generated by the reblocking unit 102. The switch 109 selects the prediction signal 128A as the prediction signal 123 to be output from the prediction signal generation unit 108 (step S203). The prediction signal 128A of the reference pixel blocks is predicted by extrapolation prediction based on the block neighboring pixels which are encoded reference pixels temporarily stored in the reference image buffer 107.

As in intra-frame encoding of H.264, one mode is selected from a plurality of prediction modes using different prediction signal generation methods for each to-be-encoded macroblock (or sub-block). More specifically, after encoding processing is performed in all prediction modes selectable for the to-be-encoded macroblock (sub-block), the encoding cost of each prediction mode is calculated. Then, an optimum prediction mode that minimizes the encoding cost is selected for the to-be-encoded macroblock (or sub-block). The encoding cost calculation method will be described later.

The selected prediction mode is set in the encoding control unit 113. The decoding apparatus side needs to prepare the same prediction mode as that on the encoding apparatus side. Hence, the encoding control unit 113 outputs the mode information 131 representing the selected prediction mode. The entropy encoding unit 110 encodes the mode information 131. When dividing the to-be-encoded macroblock into sub-blocks and encoding them in accordance with a predetermined encoding order, transform/quantization and inverse transform/inverse quantization to be described later may be executed in the prediction signal generation unit 108.

The subtracter 103 obtains, as the prediction error signal 124, the difference between the reblocked signal 122 (the image signal of the reference pixel blocks) output from the reblocking unit 102 and the prediction signal (the prediction signal 128A of the reference pixel blocks generated by the reference pixel prediction unit 108A) output from the prediction signal generation unit 108. The transform/quantization unit 104 transforms and quantizes the prediction error signal 124 (step S204). The transform/quantization unit 104 obtains transform coefficients by transforming the prediction error signal 124. The transform coefficients are quantized based on the quantization parameters set in the encoding control unit 113. The transform/quantization unit 104 outputs the transform coefficient data 125 representing the quantized transform coefficients.

At this time, the user can select by a flag whether the transform coefficient data 125 should be encoded and transmitted for each macroblock (sub-block). The selection result, i.e., the flag is set in the encoding control unit 113, output from the encoding control unit 113 as the encoded block information 133, and encoded by the entropy encoding unit 110.

The flag is, e.g., FALSE if all transform coefficients of the to-be-encoded macroblock are zero, and TRUE if at least one transform coefficient is not zero. When the flag is TRUE, all transform coefficients may be replaced with zero to forcibly change the flag to FALSE. After encoding processing is performed for both TRUE and FALSE, the encoding cost is calculated in each case. Then, an optimum flag that minimizes the encoding cost may be determined for the block. The encoding cost calculation method will be described later.

The transform coefficient data 125 of the reference pixel blocks obtained in step S204 is input to the entropy encoding unit 110 and the inverse transform/inverse quantization unit 105. The inverse transform/inverse quantization unit 105 inversely quantizes the quantized transform coefficients in accordance with the quantization parameters set in the encoding control unit 113. Next, the inverse transform/inverse quantization unit 105 performs inverse transform for the transform coefficients obtained by the inverse quantization, thereby generating the reconstructed prediction error signal 126.

The reconstructed prediction error signal 126 is added to the prediction signal 128A generated in step S203 by the reference pixel prediction unit 108A in accordance with the selected prediction mode to generate the local decoded signal 127 (step S205). The local decoded signal 127 is written in the reference image buffer 107.

Next, the interpolation pixel prediction unit 108B in the prediction signal generation unit 108 generates the prediction signal 128B in correspondence with the interpolation pixel blocks generated by the reblocking unit 102 as the reblocked signal 122. The switch 109 selects the prediction signal 128B as the prediction signal 123 (step S206). More specifically, using, e.g., a linear interpolation filter, the interpolation pixel blocks are predicted based on the encoded reference pixels (including the reference pixel blocks) temporarily stored in the reference image buffer 107. The interpolation pixel block prediction using the linear interpolation filter will be described in detail in the second embodiment.

The subtracter 103 obtains, as the prediction error signal 124, the difference between the image signal of the interpolation pixel blocks output from the reblocking unit 102 as the reblocked signal 122 and the prediction signal 123 (the prediction signal 128B of the interpolation pixel blocks generated by the interpolation pixel prediction unit 108B) output from the prediction signal generation unit 108. The transform/quantization unit 104 transforms and quantizes the prediction error signal 124 (step S207).

The transform/quantization unit 104 generates transform coefficients by transforming the prediction error signal 124. The transform coefficients are quantized based on the quantization parameters set in the encoding control unit 113. The transform/quantization unit 104 outputs the transform coefficient data 125 representing the quantized transform coefficients. The transformed transform coefficients are quantized based on the quantization parameters set in the encoding control unit 113. The encoded block information 133 of the flag to select whether the transform coefficient data 125 should be encoded and transmitted for each macroblock (sub-block) is generated in accordance with the method described in association with step S204.

The transform coefficient data 125 of the reference pixel blocks and the interpolation pixel blocks obtained in steps S204 and S207 are input to the entropy encoding unit 110. The entropy encoding unit 110 entropy-encodes the transform coefficient data 125 together with the prediction mode information 131, the block size switching information 132, and the encoded block information 133 (step S208). Finally, the multiplexing unit 111 multiplexes the encoded data 135 obtained by entropy encoding and outputs it as the encoded bitstream 136 via the output buffer 112 (step S209).

According to this embodiment, for the reference pixel blocks out of the reference pixel blocks and the interpolation pixel blocks reblocked by pixel distribution, the prediction signal 128A is generated by extrapolation prediction as in H.264, and the prediction error signal contained in the prediction signal 128A for the signal of the reference pixel blocks is encoded.

On the other hand, for the interpolation pixel blocks, the prediction signal 128B is generated by interpolation prediction using a local decoded signal corresponding to the interpolation pixel blocks and a local decoded signal corresponding to the encoded pixels, and the prediction error signal contained in the prediction signal 128B for the signal of the interpolation pixel blocks is encoded. This decreases prediction errors.

As described above, according to this embodiment, interpolation prediction for each pixel is executed in a pixel block when performing intra encoding with prediction and transform encoding for each pixel block. It is therefore possible to reduce prediction errors as compared to a method using only extrapolation prediction and improve the encoding efficiency. In addition, adaptively selecting a pixel distribution pattern for each pixel block further improves the encoding efficiency.

### Second Embodiment

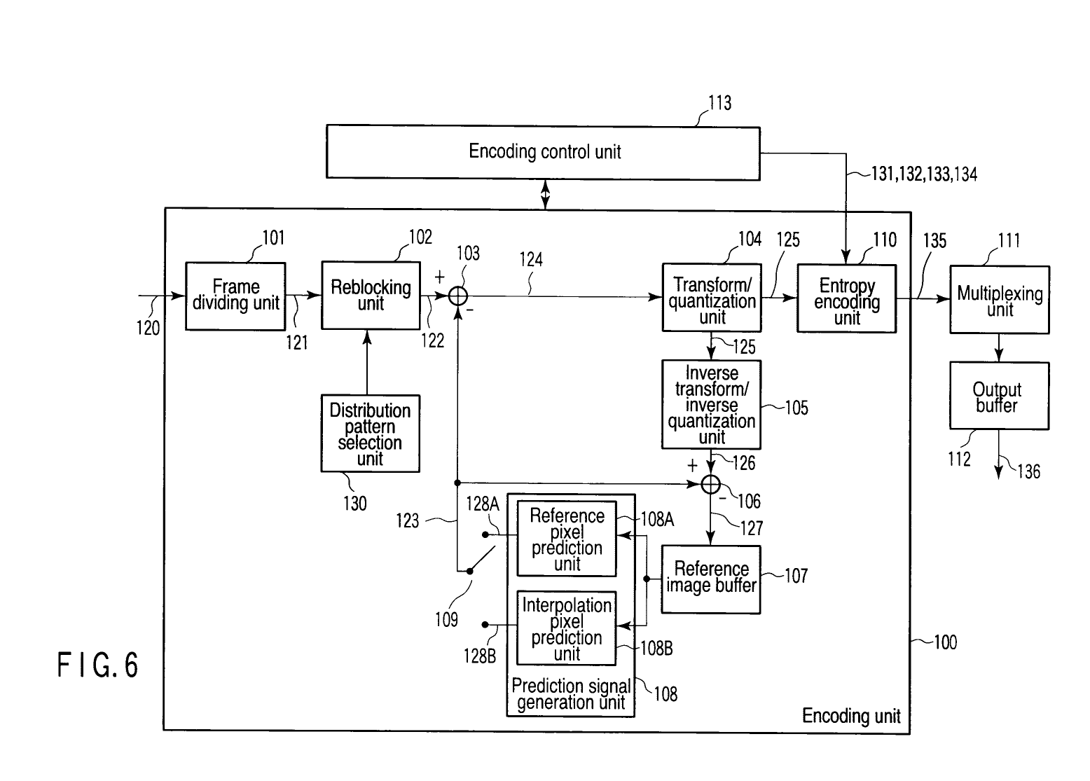

FIG. 6 shows a video encoding apparatus according to the second embodiment of the present invention. A distribution pattern selection unit 130 to select a distribution pattern of pixel distribution in a reblocking unit 102 is added to the video encoding apparatus according to the first embodiment shown in FIG. 1. An encoding control unit 113 additionally has a function of controlling the distribution pattern selection unit 130 and is accordingly designed to output distribution pattern information 134.

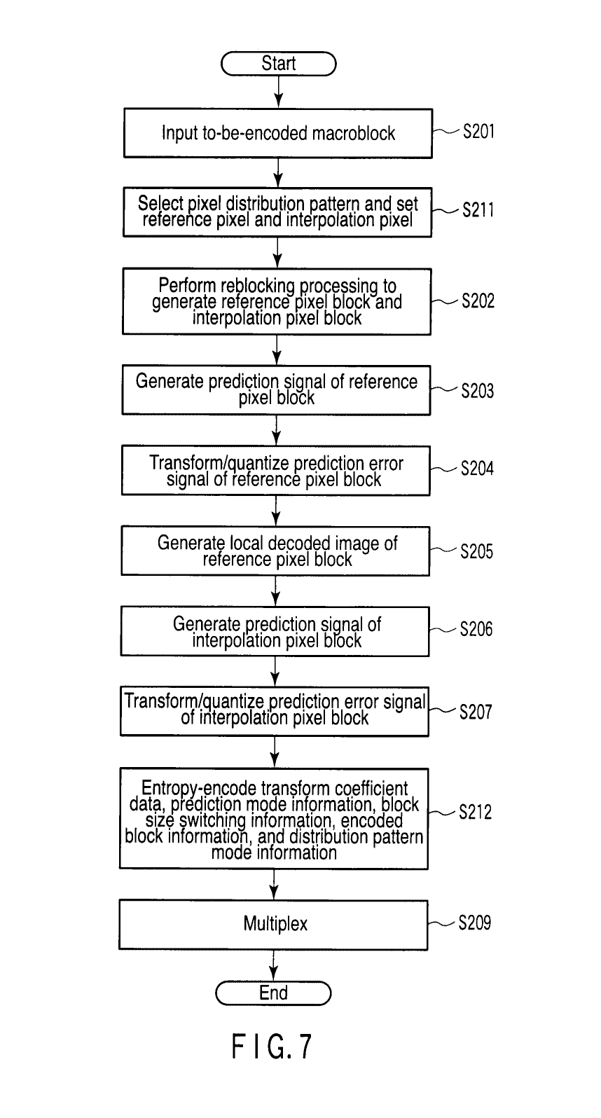

The operation of the video encoding apparatus shown in FIG. 6 will be described next in detail with reference to FIGS. 7 and 8 to 12. FIG. 7 is a flowchart illustrating the processing procedure of the video encoding apparatus in FIG. 6. Step S211 is added to FIG. 2. In addition, the process contents of step S212 corresponding to step S208 in FIG. 2 are changed.

In step S201, every time an to-be-encoded macroblock signal 121 obtained by a frame dividing unit 101 is input to an encoding unit 100, the distribution pattern selection unit 130 selects a distribution pattern. The reblocking unit 102 classifies the pixels of the to-be-encoded macroblock into reference pixels and interpolation pixels in accordance with the selected distribution pattern (step S211) and subsequently generates reference pixel blocks and interpolation pixel blocks by reblocking processing (step S202). The subsequent processes in steps S202 to S207 are fundamentally the same as in the first embodiment.

In step S212 next to step S207, the information (index) 134 representing the distribution pattern selected in step S211 is entropy-encoded together with transform coefficient data 125 of reference pixel blocks and interpolation pixel blocks, prediction mode information 131, block size switching information 132, and encoded block information 133. Finally, a multiplexing unit 111 multiplexes encoded data 135 obtained by entropy encoding and outputs it as an encoded bitstream 136 via an output buffer 112 (step S210).

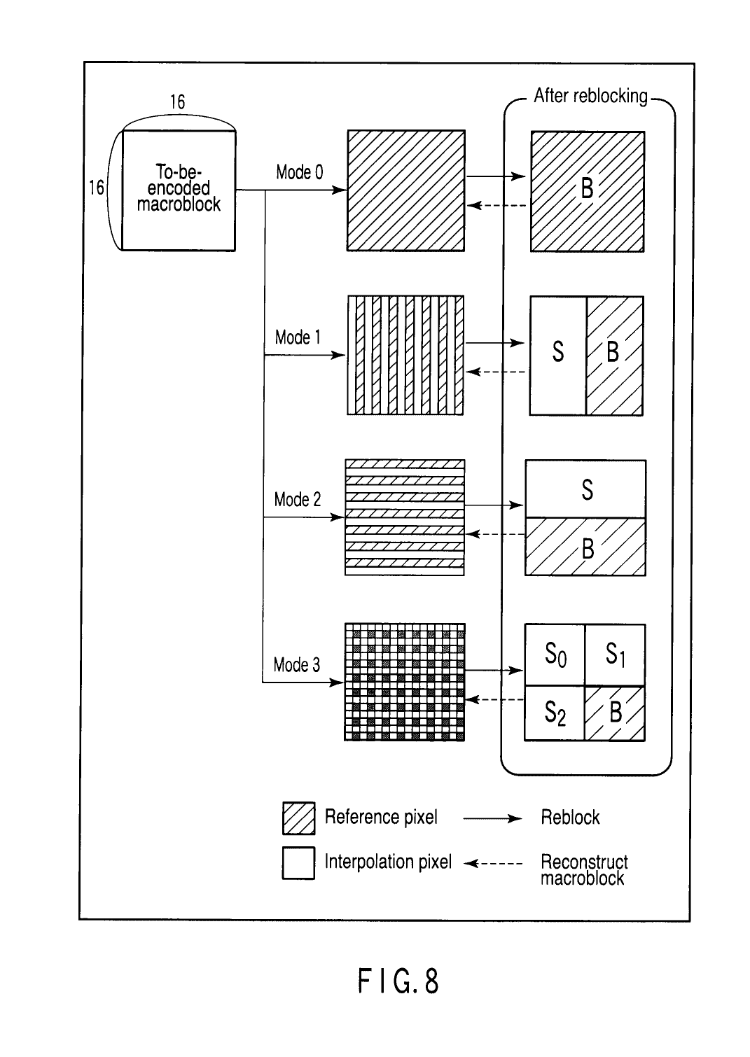

Distribution pattern selection and the processing of the reblocking unit 102 according to this embodiment will be explained below with reference to FIGS. 8, 9, and 10. In this embodiment, four kinds of patterns represented by modes 0 to 3 in FIG. 8 are prepared as distribution patterns. The distribution patterns of modes 1 to 3 are the same as the patterns shown in FIGS. 3, 4, and 5.

Let P(X,Y) be the coordinates of a pixel position in the to-be-encoded macroblock. A pixel B(x,y) in a reference pixel block B and a pixel S(x,y) in an interpolation pixel block S or pixels S₀(x,y), S₁(x,y), and S₂(x,y) in interpolation pixel blocks S₀, S₁, and S₂ are represented by the following equations 4, 5, 6 and 7.

B(x,y)=P(x,y)

S(x,y)=0 mode 0

B(x,y)=P(2x+1,y)

S(x,y)=P(2x,y) mode 1

B(x,y)=P(x,2y+1)

S(x,y)=P(x,2y) mode 2

B(x,y)=P(2x+1,2y+1)

S₀(x,y)=P(2x,2y)

S₁(x,y)=P(2x+1,2y)

S₂(x,y)=P(2x,2y+1) mode 3

Mode 0 indicates a pattern without pixel distribution. In mode 0, only a reference pixel block including 16×16 pixels is generated. Modes 1, 2, and 3 indicate the distribution patterns described in the first embodiment with reference to FIGS. 3, 4, and 5. More specifically, in mode 1, a reference pixel block and an interpolation pixel block each having 8×16 pixels are generated. In mode 2, a reference pixel block and an interpolation pixel block each having 16×8 pixels are generated. In mode 3, a reference pixel block and interpolation pixel blocks each having 8×8 pixels are generated.

A case will be described here in which when encoding the reference pixel blocks and the interpolation pixel blocks, each of them is divided into sub-blocks that are smaller pixel blocks, and each sub-block is encoded as in intra-frame encoding of H.264.

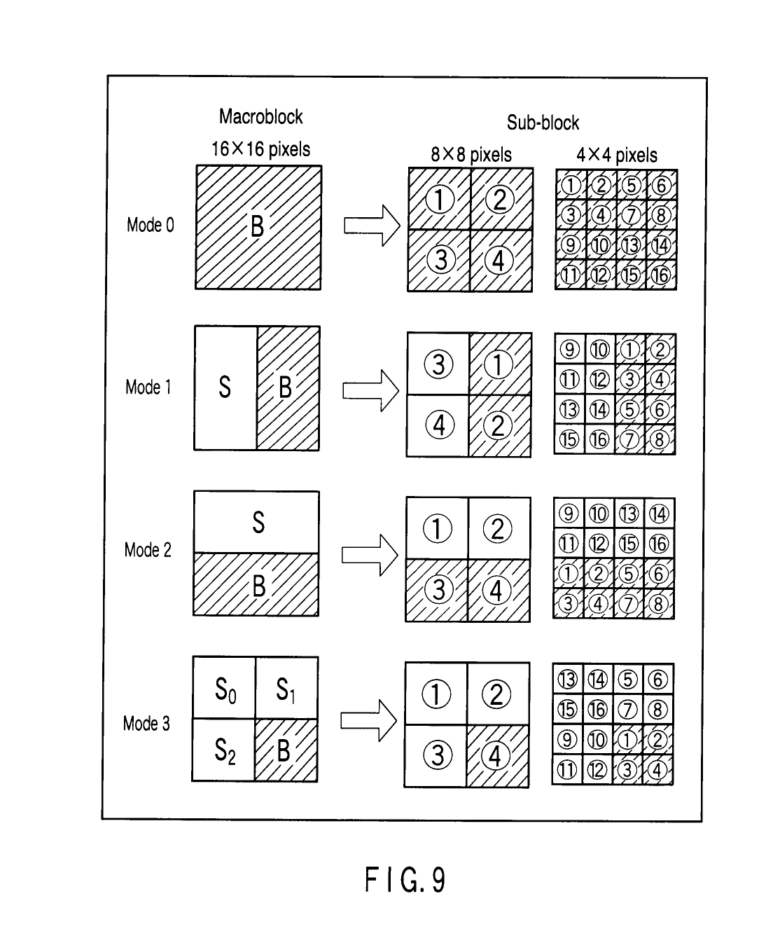

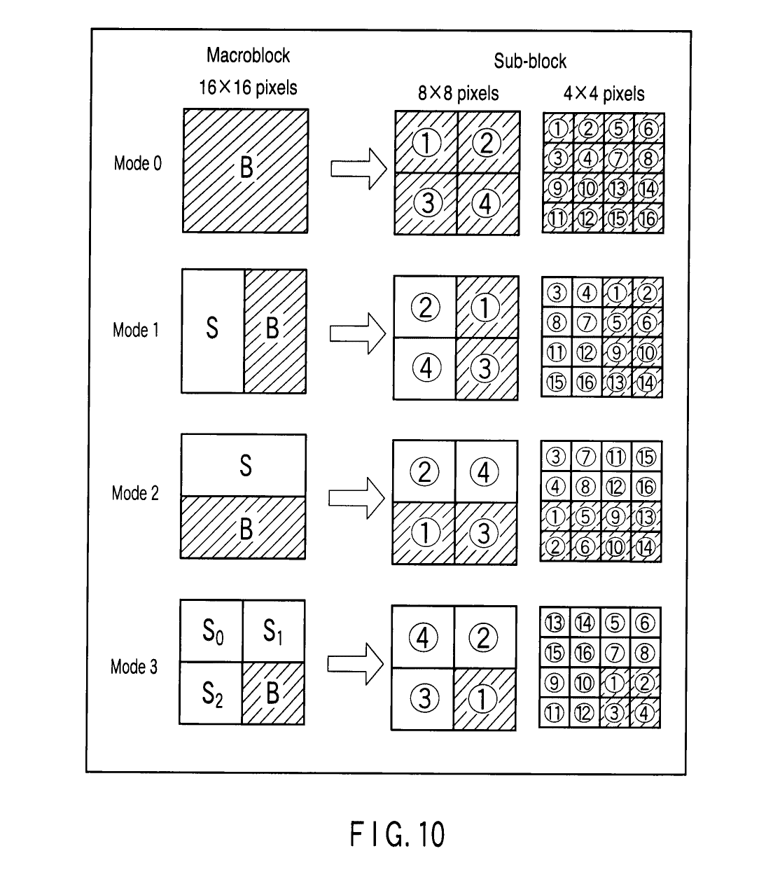

FIGS. 9 and 10 show examples in which the reference pixel blocks and the interpolation pixel blocks are divided into 8×8 pixel sub-blocks and 4×4 pixel sub-blocks in the distribution patterns of modes 1 to 3 shown in FIG. 8. Referring to FIGS. 9 and 10, one 16×16 pixel macroblock is divided into four 8×8 pixel sub-blocks or sixteen 4×4 pixel sub-blocks. Each sub-block undergoes predictive encoding in the order (encoding order) represented by circled numbers in FIGS. 9 and 10.

In the encoding order shown in FIG. 9, all reference pixel sub-blocks first undergo predictive encoding by extrapolation prediction using the local signal of encoded pixels. After that, the interpolation pixel blocks are predictive-encoded by interpolation prediction using the local decoded signal of encoded reference pixels. In the encoding order shown in FIG. 10, even encoded interpolation pixel sub-blocks can be referred to when predicting the reference pixel sub-blocks.

The sub-block size is selected in the following way. After encoding loop processing is performed for each macroblock using the 8×8 pixel and 4×4 pixel sub-block sizes, the encoding cost in each sub-block size is calculated. Then, an optimum sub-block size that minimizes the encoding cost is selected for each macroblock. The encoding cost calculation method will be described later. The thus selected sub-block size is set in the encoding control unit 113. The encoding control unit 113 outputs the block size switching information 132. An entropy encoding unit 110 encodes the block size switching information 132.

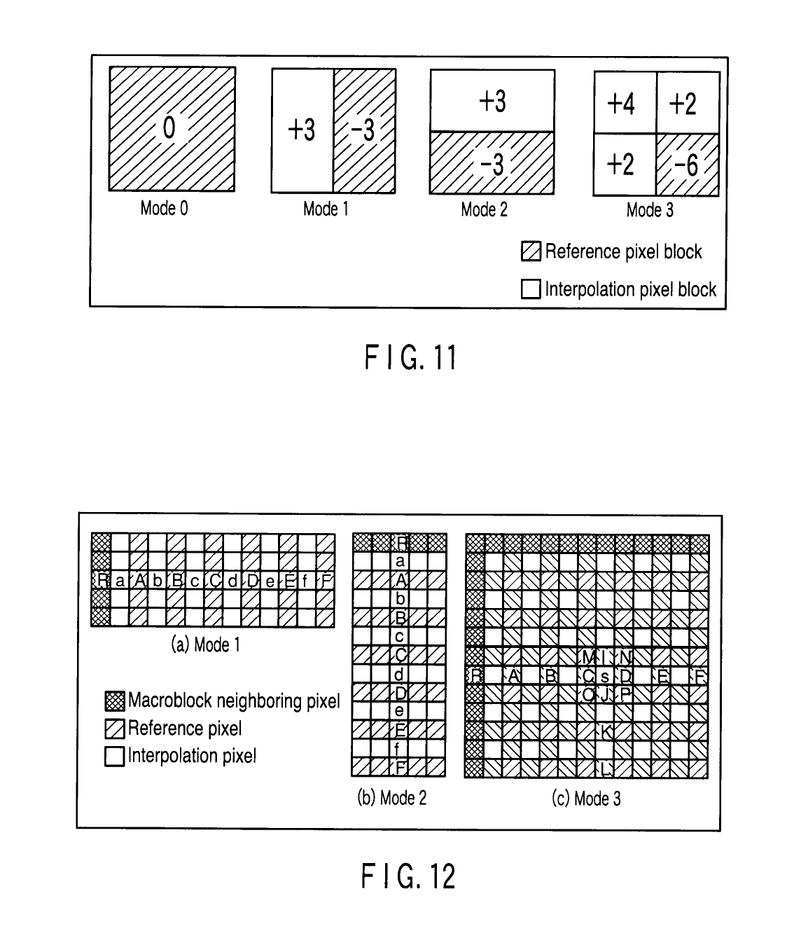

Processing of predicting the interpolation pixel blocks using a linear interpolation filter based on the encoded reference pixels (including the reference pixel blocks) temporarily stored in a reference image buffer 107 in step S206 will be explained next in detail with reference to FIG. 12(a), (b), and (c).

For example, when a distribution pattern mode 1 of the mode 1 in FIG. 8 is selected, the predicted value of an interpolation pixel d of FIG. 12(a) is expressed by the following equation 8.

d={20×(C+D)−5×(B+E)+(A+F)+16}>>5

where “>>” represents bit shift. An operation with an integer-pel accuracy using bit shift implements an interpolation filter without any calculation errors.

Using an encoded pixel R in the neighborhood of the to-be-encoded macroblock, the predicted value of an interpolation pixel c in FIG. 12(a) is expressed by the following equation 9.

c={20×(B+C)−5×(A+D)+(R+E)+16}>>5

In mode 2 as well, the interpolation pixels d and c in FIG. 12(b) can be expressed using the same equations as in mode 1. If no reference pixel exists, the nearest encoded reference pixel is copied for use.

In mode 3 shown in FIG. 12(c) in which a plurality of interpolation pixel blocks exist, if encoding is performed in the encoding order shown in, e.g., FIG. 10, interpolation pixels located in the horizontal and vertical directions with respect to the reference pixels can be predicted by the same processing as in modes 1 and 2. For an interpolation pixel s in FIG. 12(c) which is located in the diagonal directions with respect to the reference pixels, prediction can be done by the equation 10 or 11.

s={20×(C+D)−5×(B+E)+(A+F)+16}>>5

or

s={20×(I+J)−5×(H+K)+(G+L)+16}>>5

In this example, a 6-tap linear interpolation filter is used. However, the prediction method is not limited to that described above if it performs interpolation prediction using encoded reference pixels. As another method, a mean filter using, e.g., only two adjacent pixels may be used. Alternatively, when predicting the interpolation pixel s in FIG. 12(c), the predicted value may be generated using all adjacent pixels by the following equation 12.

s={(M+I+N+C+D+O+J+P)+4}>>3

As still another example, the above-described 6-tap linear interpolation filter or the mean filter using adjacent pixels may be used, or a plurality of prediction modes using different prediction signal generation methods such as a prediction mode having a directivity as in intra-frame encoding of H.264 may be prepared, and one of the modes may be selected.

As described above, according to the second embodiment, the pixel distribution pattern is adaptively switched in accordance with the properties (directivity, complexity, and texture) of each region of an image, thereby obtaining a higher encoding efficiency, in addition to the same effects as in the first embodiment.

A preferable form of quantization/inverse quantization according to the first and second embodiments will be described next in detail. As described above, the interpolation pixels are predicted using interpolation prediction based on encoded reference pixels. If the quantization width of the reference pixels is coarse (the quantization error is large), the interpolation pixel prediction may fail to hit, and the prediction errors may increase.

To prevent this, in the first and second embodiments, control is performed to make the quantization width finer for the reference pixels and coarser for the interpolation pixels. In addition, control is performed to make the quantization width finer for the reference pixels as the pixel distribution interval becomes larger. More specifically, for example, an offset value ΔQP that is the difference from a reference quantization parameter QP set in the encoding control unit 113 is set for each of the reference pixel blocks and the interpolation pixel blocks as shown in FIG. 11.

In the distribution pattern in FIG. 5 or distribution pattern mode 3 in FIG. 8, there are a plurality of interpolation pixel blocks, which are encoded in the order of, e.g., S₁→S₂→S₀ as shown in FIG. 9, and the interpolation pixel block S₀ is predicted using local decoding of the interpolation pixel blocks S₁ and S₂. In this case, ΔQP of the interpolation pixel blocks S₁ and S₂ to be referred to may be set to be smaller than ΔQP of the interpolation pixel block S₀ of the prediction target (mode 3 in FIG. 11). The offset values shown in FIG. 11 determined in accordance with the pixel distribution patterns are set in the encoding control unit 113 or a decoding control unit (to be described later) in advance as fixed values. The encoding apparatus and the decoding apparatus use the same values in quantization and inverse quantization processing.

The values ΔQP are not limited to those shown in FIG. 11 if control is performed to satisfy the above condition. For example, ΔQP that is the difference from QP is controlled here. However, the quantization width may be controlled directly. Although this increases the number of encoded bits of the reference pixels, improving the image quality of the reference pixels makes it possible to raise the correlation to adjacent interpolation pixels and reduce the prediction errors of the interpolation pixels.

In addition, ΔQP may be entropy-encoded and transmitted and then received and decoded on the decoding apparatus side for use. At this time, ΔQP may be transmitted for each of the reference pixel blocks and the interpolation pixel blocks. Alternatively, the absolute value of ΔQP may be encoded and transmitted for each macroblock so that a negative value is set for each reference pixel block, whereas a positive value is set for each interpolation pixel block. At this time, ΔQP may be set in accordance with the magnitude of prediction errors or the activity of the original picture. Otherwise, several candidate values for ΔQP are prepared, and the encoding cost for each value is calculated. Then, optimum ΔQP that minimizes the encoding cost for the block may be determined. The encoding cost calculation method will be described later. The unit of transmission need not always be a macroblock but may be a sequence, a picture, or a slice.

The aforementioned encoding cost calculation method will be explained here. When selecting pixel distribution pattern information, prediction mode information, block size information, and encoded block information, mode determination is done based on the encoding processing in units of macroblock or sub-block that is a switching unit. More specifically, mode determination is performed using, for example, a cost represented by the following equation 13.

K=SAD+λ×OH

where OH is mode information, SAD is the sum of absolute differences of prediction error signals, λ is a constant determined based on the value of a quantization width or a quantization parameter.

A mode is determined based on a thus obtained cost. More specifically, a mode in which the cost K gives the minimum value is selected as the optimum mode.

In this example, the mode information and the sum of absolute differences of prediction error signals are used. However, mode determination may be done using only the mode information or only the sum of absolute differences of prediction error signals. Values obtained by Hadamard transform or approximation of these values may be used. The cost may be obtained using the activity of the input image signal. Alternatively, a cost function may be created using the quantization width or the quantization parameter.

As another example of cost calculation, a temporary encoding unit may be provided. Mode determination may be done using the number of encoded bits obtained by actually encoding prediction error signals generated in the selected mode and the square error of the input image signal and a local decoded signal obtained by locally decoding the encoded data. In this case, the mode determination equation is given by the following equation 14.

J=D+λ×R

where D is encoding distortion representing the square error of the input image signal and the local decoded image signal, and R is the number of encoded bits estimated by temporary encoding.

When the cost of the equation 14 is used, temporary encoding and local decoding (inverse quantization processing and inverse transform processing) are necessary for each encoding mode. This enlarges the circuit scale but enables utilization of the accurate number of encoded bits and encoding distortion. It is therefore possible to maintain a high encoding efficiency. As for the cost of the equation 14, the cost may be calculated using only the number of encoded bits or only the encoding distortion, or a cost function may be created using values obtained by approximating these values.

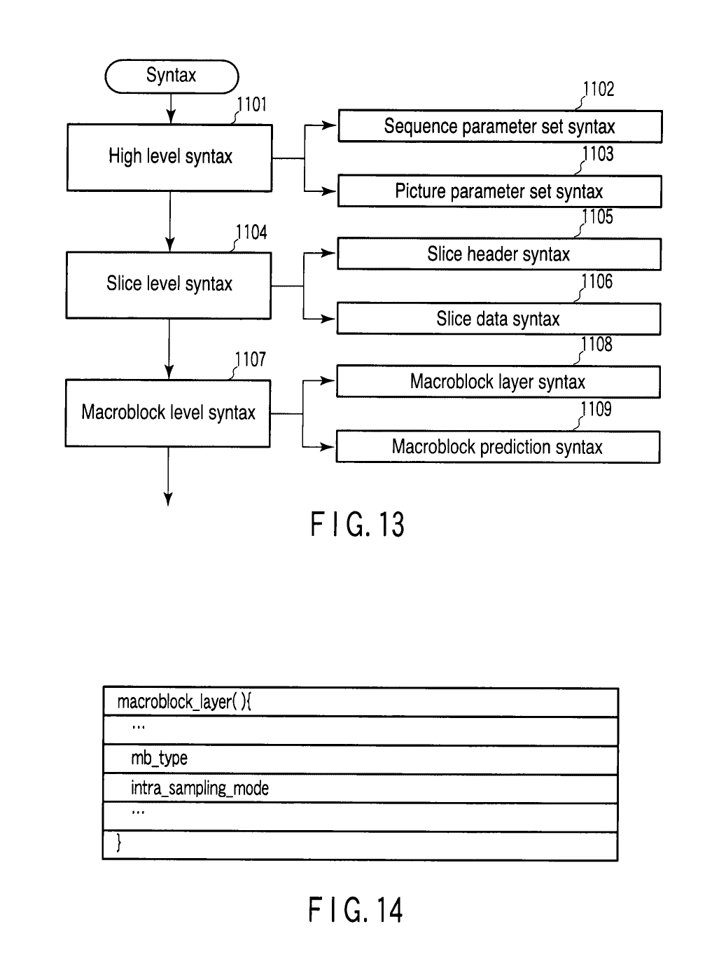

An outline of the syntax structure used in the first and second embodiments will be described next with reference to FIG. 13. The syntax mainly includes three basic parts, i.e., high level syntax 1101, slice level syntax 1104, and macroblock level syntax 1107. The high level syntax 1101 contains syntax information of upper layers above the slices. The slice level syntax 1104 specifies information necessary for each slice. The macroblock level syntax 1107 specifies transform coefficient data, mode information, and the like which are necessary for each macroblock.

Each of the three basic parts includes more detailed syntax. The high level syntax 1101 includes syntax of sequence and picture level such as sequence parameter set syntax 1102 and picture parameter set syntax 1103. The slice level syntax 1104 includes slice header syntax 1105 and slice data syntax 1106. The macroblock level syntax 1107 includes macroblock layer syntax 1108 and macroblock prediction syntax 1109.

Pieces of syntax information particularly associated with the first and second embodiments are the macroblock layer syntax 1108 and the macroblock prediction syntax 1109. Referring to FIG. 14, mb_type in the macroblock layer syntax is block size switching information in a macroblock, which determiners the encoding sub-block unit such as 4×4, 8×8, or 16×16 pixels. In FIG. 14, intra_sampling_mode in the macroblock layer syntax is an index representing the pixel distribution pattern mode in the macroblock and takes values of, e.g., 0 to 3.

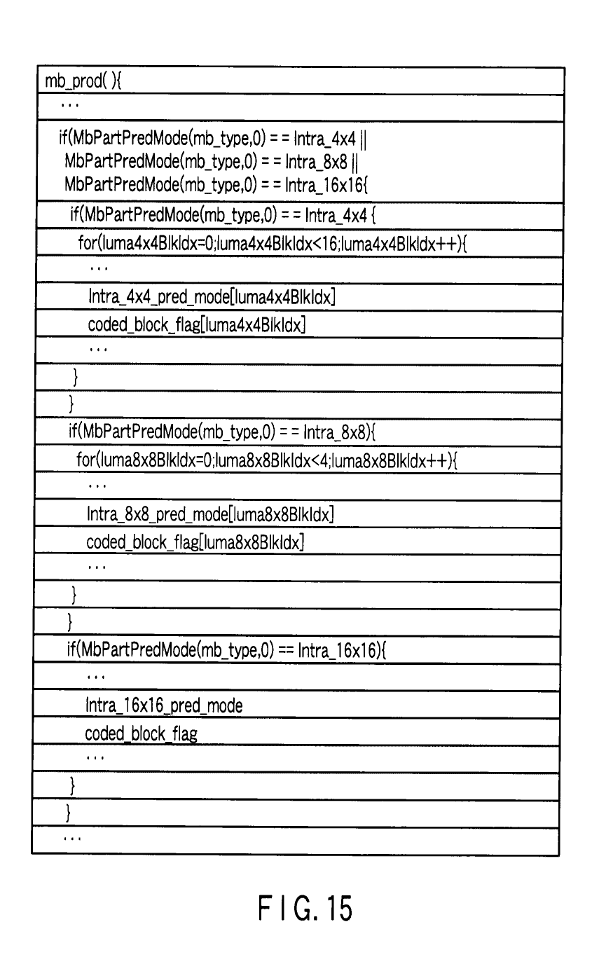

The macroblock prediction syntax in FIG. 15 specifies information about the prediction mode and encoded block of each macroblock (16×16 pixel block) or sub-block (4×4 pixel block or 8×8 pixel block). An index indicating the prediction mode of a process block unit in each mb_type is intra 4×4(8×8 or 16×16)_pred_mode. A flag coded_block_flag represents whether the transform coefficients of the process block should be transmitted. When the flag is FALSE, the transform coefficient data of the block is not transmitted. When the flag is TRUE, the transform coefficient data of the block is transmitted.

In the second embodiment, the distribution pattern of pixel distribution is switched for each macroblock having a 16×16 pixel size. However, the distribution pattern may be switched for each frame or each pixel size such as 8×8 pixels, 32×32 pixels, 64×64 pixels, or 64×32 pixels.

In the second embodiment, the unit of transmission of pixel distribution pattern mode information is a macroblock. However, this information may be transmitted for each sequence, each picture, or each slice.

In the first and second embodiments, only intra-frame prediction has been described. However, the present invention is also applicable to inter-frame prediction using correlation between frames. In this case, reference pixels are predicted not by extrapolation prediction in a frame but by inter-frame prediction.

The video encoding apparatus shown in FIG. 1 or 6 can be implemented using, e.g., a general-purpose computer apparatus as basic hardware. More specifically, the frame dividing unit 101, the pixel distribution pattern selection unit 130, the reblocking unit 102, the prediction signal generation unit 108 (the reference pixel prediction unit 108A and the interpolation pixel prediction unit 108B), the transform/quantization unit 104, the inverse transform/inverse quantization unit 105, the reference image buffer 107, the entropy encoding unit 110, the multiplexing unit 111, the output buffer 112, and the encoding control unit 113 can be implemented by causing a processor in the computer apparatus to execute a program. At this time, the video encoding apparatus may be implemented by installing the program in the computer apparatus in advance. Alternatively, the video encoding apparatus may be implemented by storing the program in a storage medium such as a CD-ROM or distributing the program via a network and installing it in the computer apparatus as needed. The reference image buffer 107 and the output buffer 112 can be implemented using a memory or hard disk provided inside or outside the computer apparatus, or a storage medium such as a CD-R, CD-RW, DVD-RAM, or DVD-R as needed.

### Third Embodiment

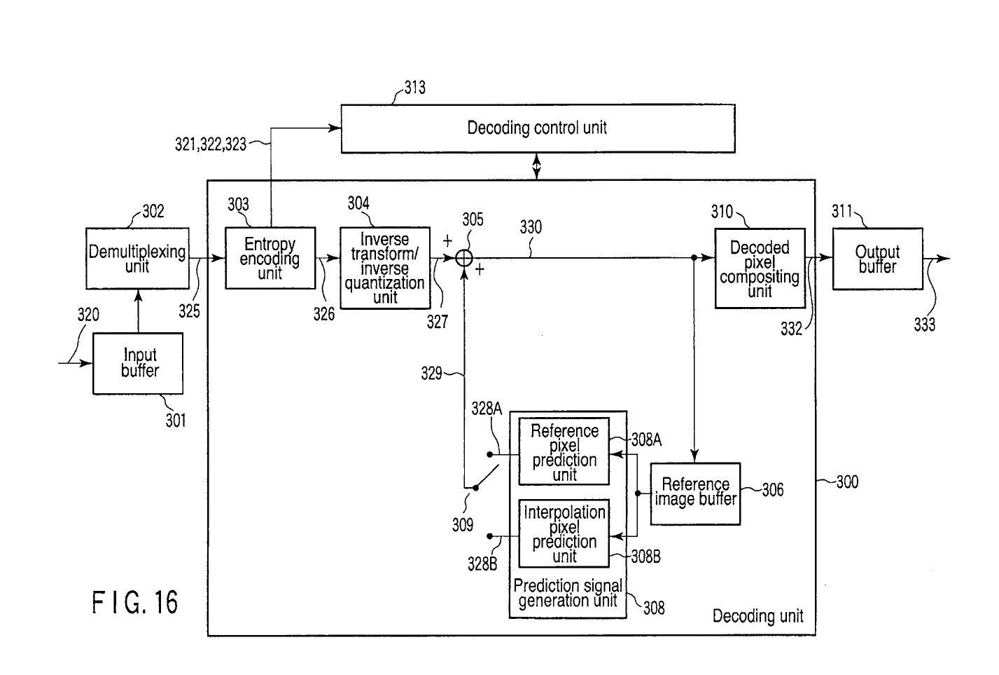

A video decoding apparatus according to the third embodiment of the present invention shown in FIG. 16 corresponds to the video encoding apparatus according to the first embodiment shown in FIG. 1. The video decoding apparatus includes a decoding unit 300, an input unit 301, a demultiplexing unit 302, an output buffer 311, and a decoding control unit 313.

The input buffer 301 temporarily stores an encoded bitstream 320 input to the video decoding apparatus. The demultiplexing unit 302 demultiplexes each encoded data based syntax and inputs it to the decoding unit 300.

An entropy decoding unit 303 receives the encoded data input to the decoding unit 300. The entropy decoding unit 303 sequentially decodes the code streams of the encoded data for each of high level syntax, slice level syntax, and macroblock level syntax according to the syntax structure shown in FIG. 13, thereby decoding quantized transform coefficients 326, prediction mode information 321, block size switching information 322, encoded block information 323, and quantization parameters. The various kinds of decoded information are set in the decoding control unit 313.

An inverse transform/inverse quantization unit 304 inversely quantizes the quantized transform coefficients 326 in accordance with the encoded block information 323, the quantization parameters, and the like, and inversely orthogonal-transforms the transform coefficients by, e.g., IDCT (Inverse Discrete Cosine Transform). Inverse orthogonal transform has been described here. However, when the video encoding apparatus has performed Wavelet transform or the like, the inverse transform/inverse quantization unit 304 may execute corresponding inverse quantization or inverse Wavelet transform.

Transform coefficient data output from the inverse transform/inverse quantization unit 304 is sent to an adder 305 as a prediction error signal 327. The adder 305 adds the prediction error signal 327 to a prediction signal 329 output from a prediction signal generation unit 308 via a switch 309 to generate a decoded image signal 330 which is input to a reference image buffer 306.

The prediction signal generation unit 308 includes a reference pixel prediction unit 308A and an interpolation pixel prediction unit 308B. Using the decoded reference pixels temporarily stored in the reference image buffer 306, the reference pixel prediction unit 308A and the interpolation pixel prediction unit 308B generate prediction signals 328A and 328B corresponding to reference pixel blocks and interpolation pixel blocks in accordance with the prediction mode information, the block size switching information, and the like set in the decoding control unit 313.

The switch 309 changes the connection point at the switching timing controlled by the decoding control unit 313 to select one of the prediction signals 328A and 328B generated by the reference pixel prediction unit 308A and the interpolation pixel prediction unit 308B. More specifically, the switch 309 first selects the prediction signal 328A corresponding to all reference pixel blocks in the to-be-decoded macroblock as the prediction signal 329. Then, the switch 309 selects the prediction signal 328B corresponding to all interpolation pixel blocks in the to-be-decoded macroblock as the prediction signal 323. The prediction signal 323 selected by the switch 309 is input to the adder 305.

A decoded pixel compositing unit 309 composites the pixels of the reference pixel blocks and the interpolation pixel blocks obtained as the decoded image signal 330, thereby generating the decoded image signal of the to-be-decoded macroblock. A generated decoded image signal 332 is sent to the output buffer 311 and output at a timing managed by the decoding control unit 313.

The decoding control unit 313 controls the entire decoding by, e.g., controlling the input buffer 301 and the output buffer 311 and controlling the decoding timing.

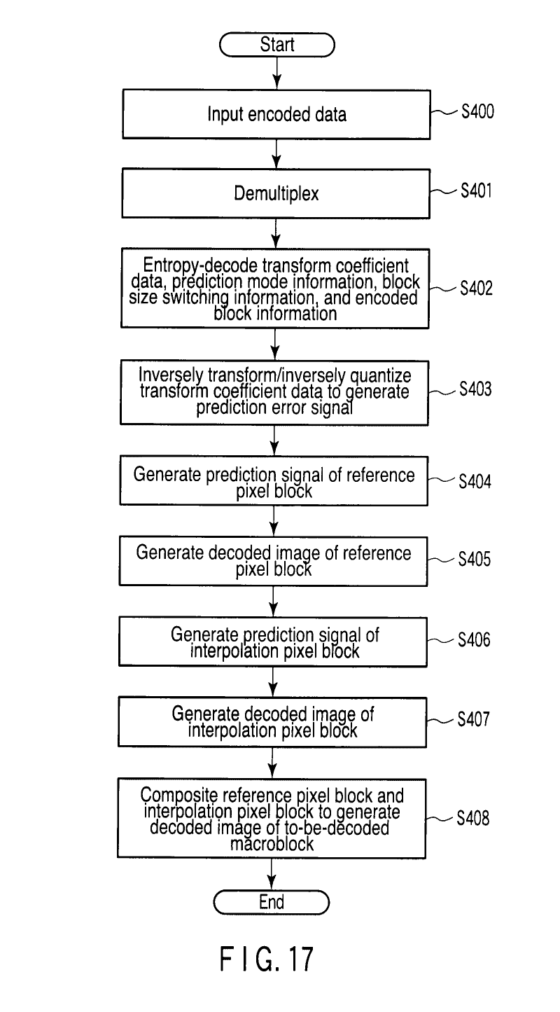

The operation of the video decoding apparatus shown in FIG. 16 will be described next in detail with reference to FIG. 17. FIG. 17 is a flowchart illustrating the processing procedure of the video decoding apparatus in FIG. 16.

First, the encoded bitstream 320 is input (step S400). The demultiplexing unit 302 demultiplexes the encoded bitstream based on the syntax structure described in the first and second embodiments (step S401). Decoding starts when each demultiplexed encoded data is input to the decoding unit 300. The entropy decoding unit 303 receives the demultiplexed encoded data input to the decoding unit 300 and decodes the transform coefficient data, the prediction mode information, the block size switching information, the encoded block information, and the like in accordance with the syntax structure described in the first and second embodiments (step S402).

The various kinds of decoded information such as the prediction mode information, the block size switching information, and the encoded block information are set in the decoding control unit 313. The decoding control unit 313 controls the following processing based on the set information.

The inverse transform/inverse quantization unit 304 receives the transform coefficient data decoded by the entropy decoding unit 303. The inverse transform/inverse quantization unit 304 inversely quantizes the transform coefficient data in accordance with the quantization parameters set in the decoding control unit 313, and then inversely orthogonal-transforms the obtained transform coefficients, thereby decoding the prediction error signals of reference pixel blocks and interpolation pixel blocks (step S403). Inverse orthogonal transform is used here. However, when Wavelet transform or the like has been performed on the video encoding apparatus side, the inverse transform/inverse quantization unit 304 may execute corresponding inverse quantization or inverse Wavelet transform.

The processing of the inverse transform/inverse quantization unit 304 is controlled in accordance with the block size switching information, the encoded block information, the quantization parameters, and the like set in the decoding control unit 313. The encoded block information is a flag representing whether the transform coefficient data should be decoded. Only when the flag is TRUE, the transform coefficient data is decoded for each process block size determined by the block size switching information.

In the inverse quantization of this embodiment, control is performed to make the quantization width finer for the reference pixels and coarser for the interpolation pixels. In addition, control is performed to make the quantization width finer for the reference pixels as the pixel distribution interval becomes larger. More specifically, values obtained by adding offset values ΔQP which are set for the reference pixel blocks and the interpolation pixel blocks as shown in FIG. 11 to reference quantization parameters QP set in the decoding control unit 313 are used. The offset values shown in FIG. 11 are fixed values determined in advance in accordance with the pixel distribution patterns. The video decoding apparatus uses the same values as those on the encoding apparatus side. The values ΔQP are not limited to those shown in FIG. 11 if control is performed to satisfy the above condition. For example, ΔQP that is the difference from QP is controlled here. However, the quantization width may be controlled directly.

As another example, the video decoding apparatus may receive ΔQP entropy-encoded on the video encoding apparatus side and decode it for use. At this time, ΔQP may be received for each of the reference pixel blocks and the interpolation pixel blocks. Alternatively, the absolute value of ΔQP may be received for each macroblock so that a negative value is set for each reference pixel block, whereas a positive value is set for each interpolation pixel block. The unit of reception need not always be a macroblock but may be a sequence, a picture, or a slice.

The prediction error signal obtained by the inverse transform/inverse quantization unit 304 is added to the prediction signal generated by the prediction signal generation unit 305 and input to the reference image buffer 306 and the decoded pixel compositing unit 310 as a decoded image signal.

The procedure of prediction processing for the reference pixel blocks and the interpolation pixel blocks or each sub-block in them will be explained next. In the following description, the processing is performed by decoding first the reference pixel blocks and then the interpolation pixel blocks.

First, the reference pixel prediction unit 308A in the prediction signal generation unit 308 generates a reference pixel block prediction signal in correspondence with the reference pixel blocks (step S404). Each reference pixel block is predicted by extrapolation prediction based on decoded pixels in the neighborhood of the block which are temporarily stored in the reference image buffer 306. This extrapolation prediction is executed by selecting one of a plurality of prediction modes using different generation methods in accordance with the prediction mode information set in the decoding control unit 313 and generating a prediction signal according to the prediction mode, as in intra-frame encoding of H.264. The video decoding apparatus side prepares the same prediction modes as those prepared in the video encoding apparatus. When performing prediction in units of 4×4 pixels or 8×8 pixels as shown in FIG. 9 or 10 in accordance with the block size switching information set in the decoding control unit 313, inverse quantization and inverse transform may be executed in the prediction signal generation unit 308.

The adder 305 adds the prediction signal generated by the reference pixel prediction unit 308A to the prediction error signal generated by the inverse transform/inverse quantization unit 304 to generate the decoded image of the reference pixel blocks (step S405). The generated decoded image signal of the reference pixel blocks is input to the reference image buffer 306 and the decoded pixel compositing unit 310.

Next, the interpolation pixel prediction unit 308B in the prediction signal generation unit 308 generates an interpolation pixel block prediction signal in correspondence with the interpolation pixel blocks (step S406). Each interpolation pixel block is predicted using a 6-tap linear interpolation filter based on the decoded reference pixels (including the reference pixel blocks) temporarily stored in the reference image buffer 308.

The adder 305 adds the prediction signal generated by the interpolation pixel prediction unit 308B to the prediction error signal generated by the inverse transform/inverse quantization unit 304 to generate the decoded image of the interpolation pixel blocks (step S406). The generated decoded image signal of the reference pixel blocks is input to the reference image buffer 306 and the decoded pixel compositing unit 310.

Using the decoded images of the reference pixel blocks and the interpolation pixel blocks generated by the above-described processing, the decoded pixel compositing unit 310 generates the decoded image signal of the to-be-decoded macroblock (step S407). The generated decoded image signal is sent to the output buffer 311 and output at a timing managed by the decoding control unit 313 as a reproduced image signal 333.

As described above, according to the video decoding apparatus of the third embodiment, it is possible to decode an encoded bitstream from the video encoding apparatus having a high prediction efficiency described in the first embodiment.

### Fourth Embodiment

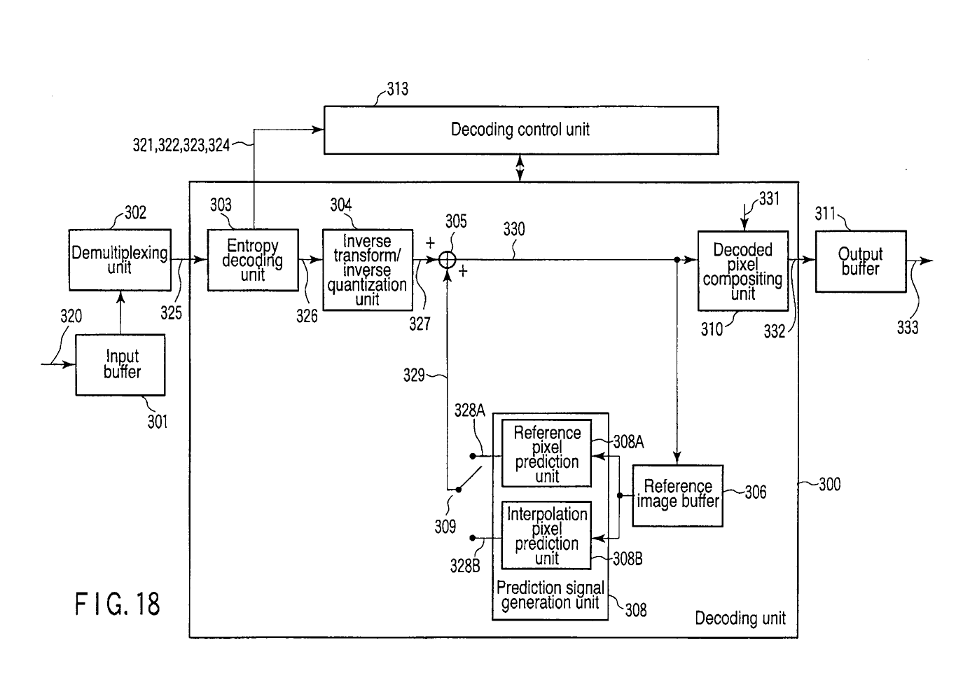

FIG. 18 shows a video decoding apparatus according to the fourth embodiment of the present invention which corresponds to the video encoding apparatus according to the second embodiment. An entropy decoding unit 303 decodes pixel distribution pattern mode information 324 and sets it in a decoding control unit 313 in addition to quantized transform coefficients, prediction mode information 321, block size switching information 322, encoded block information 323, and quantization parameters. The decoding control unit 313 supplies pixel distribution pattern information 331 to a decoded pixel compositing unit 310, unlike the video decoding apparatus according to the third embodiment shown in FIG. 6.

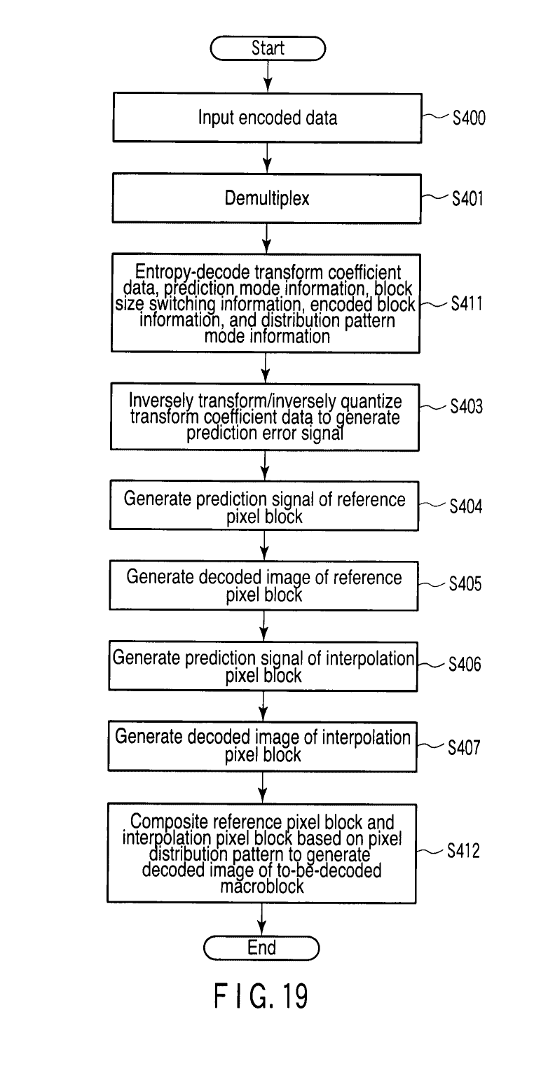

FIG. 19 is a flowchart illustrating the processing procedure of the video decoding apparatus in FIG. 18. Steps S411 and 5412 replace steps S402 and S408 in FIG. 17. In step S411, the entropy decoding unit 303 receives demultiplexed encoded data input to a decoding unit 300 and decodes the pixel distribution pattern mode information in addition to the transform coefficient data, the prediction mode information, the block size switching information, the encoded block information in accordance with the syntax structure described in the first and second embodiments.

In step S406, an interpolation pixel prediction unit 308B in a prediction signal generation unit 308 predicts interpolation pixel blocks using a 6-tap linear interpolation filter based on decoded reference pixels (including reference pixel blocks) temporarily stored in a reference image buffer 308, as described in the third embodiment.

The process in step S406 will be described here in more detail. For example, as shown in FIG. 12, when pixel distribution pattern mode 1 in FIG. 8 is selected, the predicted value of an interpolation pixel d in FIG. 12 (a) is represented by the equation 8. The predicted value of an interpolation pixel c in FIG. 12(a) is represented by the equation 9 using a decoded pixel R in the neighborhood of the to-be-decoded macroblock. In mode 2 as well, the interpolation pixels d and c in FIG. 12(b) can be expressed using the same equations as in mode 1. If no reference pixel exists, the nearest decoded reference pixel is copied for use. In mode 3 shown in FIG. 8 in which a plurality of interpolation pixel blocks exist, if encoding is performed in the encoding order shown in, e.g., FIG. 9, interpolation pixels located in the horizontal and vertical directions with respect to the reference pixels can be predicted by the same processing as in modes 1 and 2. For an interpolation pixel s in FIG. 12(c) which is located in the diagonal directions with respect to the reference pixels, prediction can be done by the equation 10 or the equation 11.

In this example, a 6-tap linear interpolation filter is used. However, the prediction method is not limited to that described above if it uses decoded reference pixels. As another method, a mean filter using, e.g., only two adjacent pixels may be used. Alternatively, when predicting the interpolation pixel in FIG. 12(c), the predicted value may be generated using all adjacent pixels by the equation 12. As still another example, the above-described 6-tap linear interpolation filter or the mean filter using adjacent pixels may be used, or a plurality of prediction modes using different prediction signal generation methods such as prediction having a directivity as in intra-frame encoding of H.264 may be prepared, and one of the modes may be selected based on the prediction mode information set in the decoding control unit 313. In this case, the video encoding apparatus side needs to prepare the same prediction modes and transmit one of them as prediction mode information.

In step S412, the decoded pixel compositing unit 310 composites the decoded images of the to-be-decoded macroblock by one of the equation 4 to the equation 7 in accordance with the pixel distribution pattern mode information 324 supplied from the decoding control unit

The video decoding apparatuses according to the third and fourth embodiments can be implemented using, e.g., a general-purpose computer apparatus as basic hardware. More specifically, the input buffer 301, the demultiplexing unit 302, the entropy decoding unit 303, the inverse transform/inverse quantization unit 304, the prediction signal generation unit 308 (the reference pixel prediction unit 308A and the interpolation pixel prediction unit 308B), the reference image buffer 306, the decoded pixel compositing unit 310, the output buffer 311, and the decoding control unit 313 can be implemented by causing a processor in the computer apparatus to execute a program. At this time, the video decoding apparatus may be implemented by installing the program in the computer apparatus in advance. Alternatively, the video decoding apparatus may be implemented by storing the program in a storage medium such as a CD-ROM or distributing the program via a network and installing it in the computer apparatus as needed. The input buffer 301, the reference image buffer 306, and the output buffer 311 can be implemented using a memory or hard disk provided inside or outside the computer apparatus, or a storage medium such as a CD-R, CD-RW, DVD-RAM, or DVD-R as needed.

Note that the present invention is not exactly limited to the above embodiments, and constituent elements can be modified in the stage of practice without departing from the spirit and scope of the invention. Various inventions can be formed by properly compositing a plurality of constituent elements disclosed in the above embodiments. For example, several constituent elements may be omitted from all the constituent elements described in the embodiments. In addition, constituent elements throughout different embodiments may be properly composited.

### INDUSTRIAL APPLICABILITY

The present invention is usable for a high-efficiency compression coding/decoding technique for a moving image or a still image.

1. A video encoding method comprising:
dividing an input image into a plurality of to-be-encoded blocks;
selecting one distribution pattern from a plurality of distribution patterns prepared in advance;
reblocking the to-be-encoded block by distributing each pixel in the to-be-encoded block to a first pixel block and a second pixel block at a predetermined interval in accordance with the one distribution pattern;
performing prediction for the first pixel block using a first local decoded image corresponding to an encoded pixel to generate a first predicted image;
encoding a first prediction error representing a difference between the first pixel block and the first predicted image to generate first encoded data;
generating a second local decoded image corresponding to the first pixel block using the first prediction error;
performing prediction for the second pixel block using the first local decoded image and the second local decoded image to generate a second predicted image;
encoding a second prediction error representing a difference between the second pixel block and the second predicted image to generate second encoded data; and
multiplexing the first encoded data and the second encoded data to generate an encoded bitstream.

2. An video encoding apparatus comprising:
a dividing unit which divides an input image into a plurality of to-be-encoded blocks;
a selection unit to select one distribution pattern from a plurality of distribution patterns prepared in advance;
a reblocking unit to reblock by distributing each pixel in the to-be-encoded block to a first pixel block and a second pixel block at a predetermined interval in accordance with the one distribution pattern;
a first prediction unit to perform prediction for the first pixel block using a first local decoded image corresponding to an encoded pixel to generate a first predicted image;
a generation unit to generate a second local decoded image corresponding to the first pixel block using a first prediction error representing a difference between the first pixel block and the first predicted image;
a second prediction unit to perform prediction for the second pixel block using the first local decoded image and the second local decoded image to generate a second predicted image;
an encoding unit to encode the first prediction error and a second prediction error representing a difference between the second pixel block and the second predicted image to generate first encoded data and second encoded data; and
a multiplexing unit to multiplex the first encoded data and the second encoded data to generate an encoded bitstream.

3-4. (canceled)

5. The video encoding apparatus according to claim 2, wherein the encoding unit is configured to further encode an index representing the one distribution pattern for each encoding sequence, each encoded frame, or each local region in the encoded frame.

6-8. (canceled)

9. The video encoding apparatus according to claim 2, wherein the encoding unit comprises a transform unit to perform orthogonal transform on the first prediction error and the second prediction error to generate a first transform coefficient and a second transform coefficient, and a quantization unit to quantize the first transform coefficient at a first quantization width and the second transform coefficient at a second quantization width larger than the first quantization width.

10. The video encoding apparatus according to claim 2, wherein the encoding unit comprises a transform unit to perform orthogonal transform on the first prediction error and the second prediction error to generate a first transform coefficient and a second transform coefficient, and a quantization unit to quantize the first transform coefficient at a first quantization width that is controlled to become smaller as a distribution interval of the distribution pattern becomes larger, and the second transform coefficient at a second quantization width.

11. The video encoding apparatus according to claim 2, wherein the reblocking unit is configured to distribute, to the first pixel block, a pixel located at a spatial position relatively distant from an encoded pixel in the neighborhood of the to-be-encoded block.

12. The video encoding apparatus according to claim 2, wherein the reblocking unit is configured to further divide the first pixel block and the second pixel block into at least one first sub block and one second sub block, respectively, and
the first prediction unit and the second prediction unit are configured to perform prediction for the first pixel block and the second pixel block for each of the first sub block and for each of the second sub block.

13. The video encoding apparatus according to claim 12, wherein the reblocking unit is configured to change a size of the first sub block and the second sub block, and
the encoding unit is configured to further encode block size information representing the size.

14-15. (canceled)

16. The video encoding apparatus according to claim 2, wherein the reblocking unit is configured to distribute one of a pixel on an odd numbered row of the to-be-encoded block and a pixel on an even numbered row to the first pixel block and the other to the second pixel block.

17. The video encoding apparatus according to claim 2, wherein the reblocking unit is configured to distribute one of a pixel on an odd numbered column of the to-be-encoded block and a pixel on an even numbered column to the first pixel block and the other to the second pixel block.

18. The video encoding apparatus according to claim 2, wherein the reblocking unit is configured to perform the reblocking by dividing the to-be-encoded block into (1) a first block including pixels on odd numbered rows and odd numbered columns, (2) a second block including pixels on odd numbered rows and even numbered columns of the pixel block, (3) a third block including pixels on even numbered rows and odd numbered columns of the pixel block, and (4) a fourth block including pixels on even numbered rows and even numbered columns of the pixel block, and distributing one of the first block, the second block, the third block, and the fourth block to the first pixel block and remaining three blocks of the first block, the second block, the third block, and the fourth block to the second pixel block.

19. The video encoding apparatus according to claim 2, wherein the reblocking unit comprises a mode selection unit which selects, as a prediction mode for the to-be-encoded block, one of
(A) a first prediction mode to distribute one of a first block including pixels on odd numbered rows of the to-be-encoded block and a second block including pixels on even numbered rows of the to-be-encoded block, to the first pixel block, and the other of the first block and the second block to the second pixel block,
(B) a second prediction mode to distribute one of a third block including pixels on odd numbered columns of the to-be-encoded block and a fourth block including pixels on even numbered columns of the to-be-encoded block to the first pixel block, and the other of the third block and the fourth block to the second block, and
(C) a third prediction mode to distribute one of (1) a fifth block including pixels on odd numbered rows and odd numbered columns of the to-be-encoded block, (2) a sixth block including pixels on odd numbered rows and even numbered columns of the to-be-encoded block, (3) a seventh block including pixels on even numbered rows and odd numbered columns of the to-be-encoded block, and (4) an eighth block including pixels on even numbered rows and even numbered columns of the to-be-encoded block to the first pixel block, and remaining three blocks of the fifth block, the sixth block, the seventh block, and the eighth block to the second pixel block, and
which is configured to generate the first pixel block and the second pixel block in accordance with the prediction mode for the to-be-encoded block.

20. An image decoding method comprising:
demultiplexing an encoded bitstream including an index representing a distribution pattern to separate first encoded data and second encoded data;
decoding the first encoded data to generate a first prediction error corresponding to a first pixel block in a decoding target block including the first pixel block and a second pixel block which are distributed in accordance with the distribution pattern;
decoding the second encoded data to generate a second prediction error corresponding to the second pixel block in the decoding target block and further decoding the index to obtain the distribution pattern;
performing prediction for the first pixel block using a first local decoded image corresponding to a decoded pixel to generate a first predicted image;
generating a second local decoded image corresponding to the first pixel block based on the first prediction error;
performing prediction for the second pixel block using the first local decoded image and the second local decoded image to generate a second predicted image;
adding the first prediction error and the first predicted image to generate a first decoded image;
adding the second prediction error and the second predicted image to generate a second decoded image; and
compositing the first decoded image and the second decoded image in accordance with the distribution pattern to generate a reproduced image signal corresponding to the decoding target block.

21. An image decoding apparatus comprising:
a demultiplexing unit to demultiplex an encoded bitstream including an index representing a distribution pattern to separate first encoded data and second encoded data;
a decoding unit to decode the first encoded data and the second encoded data to generate a first prediction error and a second prediction error corresponding to a first pixel block and a second pixel block, respectively, in a decoding target block including the first pixel block and the second pixel block distributed in accordance with the distribution pattern and further decode the index to obtain the distribution pattern;
a first prediction unit to perform prediction for the first pixel block using a first local decoded image corresponding to a decoded pixel to generate a first predicted image;
a generation unit to generate a second local decoded image corresponding to the first pixel block based on the first prediction error;
a second prediction unit to perform prediction for the second pixel block using the first local decoded image and the second local decoded image to generate a second predicted image;
an adder to add the first prediction error and the first predicted image to generate a first decoded image and add the second prediction error and the second predicted image to generate a second decoded image; and
a compositing unit to composite the first decoded image and the second decoded image in accordance with the distribution pattern to generate a reproduced image signal corresponding to the decoding target block.

22-23. (canceled)

24. The image decoding apparatus according to claim 21, wherein the decoding unit is configured to further decode the index for each encoding sequence, each encoded frame, or each local region in the encoded frame.

25-27. (canceled)

28. The image decoding apparatus according to claim 21, wherein the first encoded data and the second encoded data include a first quantized transform coefficient and a second quantized transform coefficient corresponding to the first pixel block and the second pixel block, respectively, and
the decoding unit comprises an inverse quantization unit to inversely quantize the first quantized transform coefficient at a first quantization width to generate a first transform coefficient and the second quantized transform coefficient at a second quantization width larger than the first quantization width to generate a second transform coefficient, and an inverse orthogonal transform unit to perform inverse orthogonal transform for the first transform coefficient and the second transform coefficient to generate the first prediction error and the second prediction error.

29. The image decoding apparatus according to claim 21, wherein the first encoded data and the second encoded data include a first quantized transform coefficient and a second quantized transform coefficient corresponding to the first pixel block and the second pixel block, respectively, and
the decoding unit comprises an inverse quantization unit to inversely quantize the first quantized transform coefficient at a first quantization width that is controlled to become smaller as an interval of the distribution pattern becomes larger, and the second quantized transform coefficient at a second quantization width, and an inverse orthogonal transform unit to perform inverse orthogonal transform on the first transform coefficient and the second transform coefficient to generate the first prediction error and the second prediction error.

30. The image decoding apparatus according to claim 21, wherein the first pixel block includes a pixel located at a spatial position relatively distant from a decoded pixel in the neighborhood of the decoding target block.

31. The image decoding apparatus according to claim 21, wherein the first pixel block and the second pixel block are divided into first sub blocks and second sub blocks, respectively, and
the first prediction unit and the second prediction unit are configured to perform prediction for the first pixel block and the second pixel block for each first sub block and each second sub block.

32. The image decoding apparatus according to claim 21, wherein the encoded stream includes information representing a size of the first sub block and the second sub block, and
the decoding unit is configured to further decode block size information representing the size.

33. (canceled)

34. An video encoding method comprising:
a dividing step of dividing an input image into a plurality of to-be-encoded blocks;
a selecting step of selecting one distribution pattern from a plurality of distribution patterns prepared in advance;
a reblocking step of distributing each of the to-be-encoded blocks into a plurality of pixel blocks by distributing each pixel in the to-be-encoded blocks at a predetermined interval in accordance with said one distribution pattern;
a predicting step of predicting a predicted image of each of the pixel blocks using a local decoded image corresponding to an encoded pixel and/or a local decoded image corresponding to a predicted pixel block of the plurality of pixel blocks;
a transform/quantization step of performing orthogonal transform and quantization on a prediction error image representing a difference between each pixel block and each predicted image to generate a transformed and quantized signal;
a local decoding step of generating a local decoded image corresponding to each pixel block; and
an encoding step of encoding the transformed and quantized signal of each pixel block.

35. The video encoding method according to claim 34, wherein the reblocking step includes generating two pixel blocks by distributing each pixel of the to-be-encoded blocks for every one row.

36. The video encoding method according to claim 34, wherein the reblocking step includes generating two pixel blocks by distributing each pixel of the to-be-encoded blocks for every one column.

37. The video encoding method according to claim 34, wherein the reblocking step includes generating four pixel blocks by distributing each pixel of the to-be-encoded blocks for every one row and one column.

38. The video encoding method according to claim 34, wherein the reblocking step includes distributing each pixel of the to-be-encoded blocks into a plurality of pixel blocks (A) for every one row, (B) for every one column or (C) for every one row and one column, and
the encoding step includes further encoding information representing a type of distribution processing in the reblocking step.

39. The video encoding method according to claim 38, wherein the reblocking step includes performing one type of the distribution processing on each to-be-encoded block in an encoding sequence, an encoded frame, or a local region in the encoded frame, and
the encoding step including information representing the type of the distribution processing for each encoding sequence, for each encoded frame, or for each local region in the encoded frame.

40. The video encoding method according to claim 34, wherein the reblocking step includes a step of dividing each of the to-be-encoded blocks into at least one sub block, and
the predicting step includes performing prediction for each sub block.

41. The video encoding method according to claim 34, wherein the step of dividing into the sub block in the reblocking step includes dividing each of the pixel blocks into sub blocks having a variable size, and
the encoding step includes encoding block size information representing the size.
